(19) United States
(12) Patent Application Publication
(10) Pub. No.: US 2010/0214268 A1
(43) Pub. Date: Aug. 26, 2010

(54) Optical touch liquid crystal display device

(76) Inventors: Ming-Wei Huang, Taoyuan County (TW); Cheng-Sheng Chiang, Taipei County (TW); Mei-Chi Fu, Taoyuan County (TW); Chien-Pang Lee, Taoyuan City (TW)

Correspondence Address: NORTH AMERICA INTELLECTUAL PROPERTY CORPORATION, P.O. BOX 506, MERRIFIELD, VA, 22116, US

(21) Appl. No.: 12/436,752

(22) Filed: May 6, 2009

(30) Foreign Application Priority Data
Feb. 23, 2009 (TW) 098105620

(51) Int. Cl. G06F 3/042; G09G 3/36

(52) U.S. Cl. 345/175; 345/87

(57) ABSTRACT

The present invention relates to an optical touch liquid crystal display device comprising a liquid crystal display panel for displaying an image, a backlight unit disposed beneath the liquid crystal display panel for providing a backlight for the liquid crystal display panel, a bezel, at least a light emitting element, and at least an optical sensor. The bezel comprises an inside surface having a horizontal surface and a vertical surface. The bezel surrounds and fixes the liquid crystal display panel and the backlight unit. The light emitting unit is disposed on the inside surface of the bezel for providing light to form an optical matrix at the image display side of the liquid crystal display panel. The optical sensor is disposed on the inside surface of the bezel for detecting a touch on the liquid crystal display panel.

### BACKGROUND OF THE INVENTION

1. Field of the Invention

The present invention relates to a liquid crystal display (LCD) device, and particularly to an optical touch LCD device.

2. Description of the Prior Art

Currently, in the market of various types of consumption electronic products, touch panels have been widely utilized in portable electronic products, such as personal digit assistants (PDA), mobile phones, tablet PC and the like, as an interface tool for communication between the device and users. Besides meeting with the requirement for multilevel menu design, touch panels possess operation functions like input by keyboard, mouse, and the like, as well as input by hand-writing panel, in more humanized way. Especially, they surpass other conventional input devices due to the characteristic of the integration of input and output functions into one interface, i.e. display, also referred to as screen.

FIG. 1 shows a schematic explosive view illustrating a conventional LCD device structure. The conventional LCD module has a bezel 12, a LCD panel 14, and a backlight unit 16. However, conventional LCD devices with touch panel function in a mode of resistance, capacitance, and the like, are generally formed by stacking a common LCD module, such as an LCD device 10, made by an LCD panel manufacturer and a detection panel made by a detection panel manufacturer together. Such device can be rendered the function of touch control, but the disadvantage is that it is thick and heavy due to formation by stacking two devices.

Therefore, there is still a need for a novel touch LCD device being relatively light and thin for convenient use.

### SUMMARY OF THE INVENTION

One objective of the present invention is to provide an optical touch LCD device, which is relatively light and thin to reduce the thickness of the optical touch display module and the fabrication cost.

The optical touch LCD device according to the present invention comprises an LCD panel for displaying an image, a backlight unit disposed beneath the LCD panel for providing a backlight for the LCD panel, a bezel, at least a light emitting element, and at least a light sensor. The bezel comprises an inside surface having a horizontal surface and a vertical surface, and the bezel surrounds and fixes the LCD panel and the backlight unit together. The light emitting element is disposed on the inside surface of the bezel for providing light to form an optical matrix at the image display side of the LCD panel. The optical sensor is disposed on the inside surface of the bezel for detecting a touch on the LCD panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic explosive view illustrating a conventional LCD device structure;

FIG. 2 is a schematic explosive view illustrating the structure of the optical touch LCD device according to the present invention;

FIG. 3 is a schematic diagram illustrating an embodiment of the present invention, in which the light emitting elements for optical touch performance and the optical sensor are disposed on the horizontal surface of the inside surface of the bezel;

FIG. 4 is a schematic diagram illustrating another embodiment of the present invention, in which the light emitting elements for optical touch performance and the optical sensor are disposed on the vertical surface of the inside surface of the bezel;

FIGS. 5-11 are schematic diagrams illustrating further some alternatives in the present invention for the layout of the light emitting elements and the optical sensors on the inside surface of the bezel;

FIG. 12 is a schematic diagram illustrating the combination of the bezel having the light emitting elements and the optical sensors disposed thereon and the backlight unit in the present invention;

FIG. 13 is a schematic cross-sectional view illustrating the combination of the bezel having the light emitting elements and the optical sensors disposed thereon and the backlight unit in the present invention; and

FIG. 14 is a schematic diagram illustrating the light emitting element structure in an embodiment of the present invention.

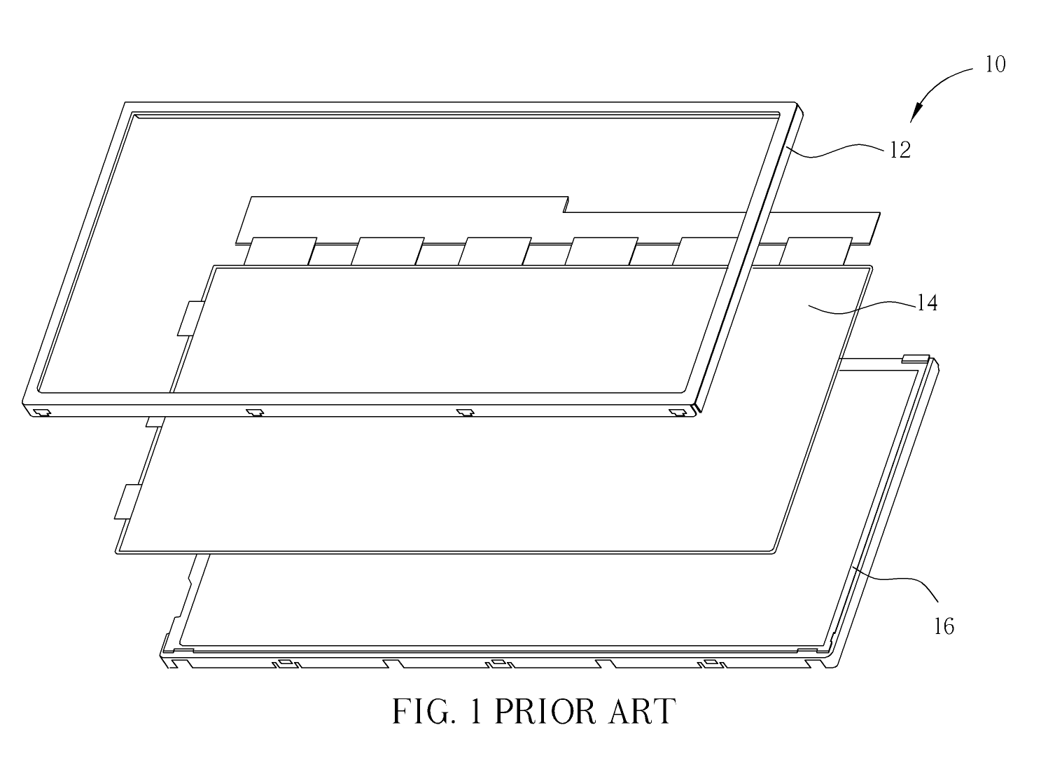

### DETAILED DESCRIPTION

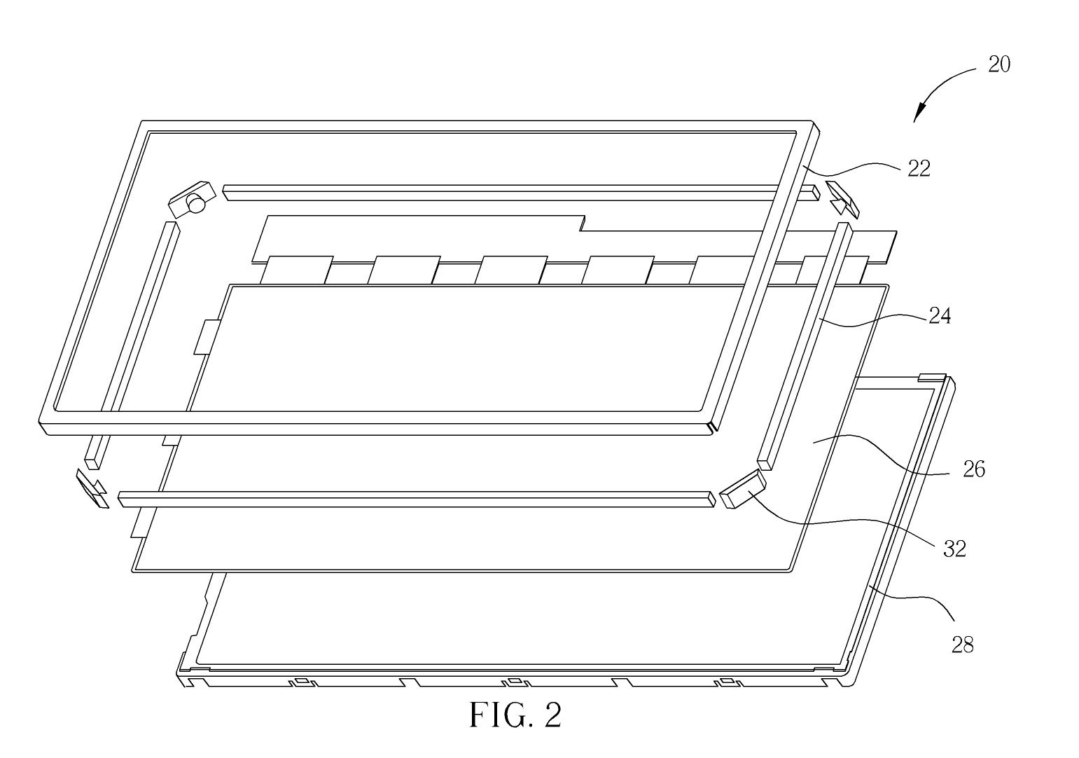

The present invention relates to an integrated optical multi-touch TFT-LCD module. As shown in FIG. 2, the optical touch LCD device 20 according to the present invention includes an LCD panel 26, a backlight unit 28, a bezel 22, at least a light emitting element 24, and at least a light sensor 32. The LCD panel 26 is for displaying an image. The backlight unit 28 is disposed beneath the LCD panel 26 for providing a backlight for the LCD panel 26. The bezel 22 includes an inside surface. The inside surface has a horizontal surface and a vertical surface. The LCD panel 26 is placed over the backlight unit 28 and both are surrounded and fixed together by the bezel 22. The light emitting element 24 is disposed on the inside surface of the bezel 22 for providing light to form an optical matrix at the image display side of the LCD panel 26. The optical sensor 32, disposed on the inside surface of the bezel 22, receives the light emitted from the light emitting element 24. When users touch (or press) the LCD panel, the intensity of the light reaching the optical sensor is changed, and accordingly, the touch to the LCD panel is detected.

The LCD panel may be a conventional LCD panel. The backlight unit may be a conventional backlight unit. The bezel may be formed of, for example, iron, wood, plastics, carbon fiber, and the like, but not limited thereto. A material able to offer strong support is preferred. The light emitting element is an element able to emit light an may be, for example, a light bulb, a light tube, a light emitting diode (LED), and the like. LED is preferred due to small size and low energy consumption. When it is not desirable for colored light to be present on the LCD panel, invisible light, such as UV light, infrared (IR) light, or far-infrared light, is preferably utilized. The infrared light or far-infrared light is more preferred The optical sensor is not particularly limited as long as it is able to detect the change of the light and has a sufficiently small volume. The optical sensor may be for example charge-coupled device (CCD) optical sensor, complementary metal-oxide-semiconductor (CMOS) optical sensor, and the like.

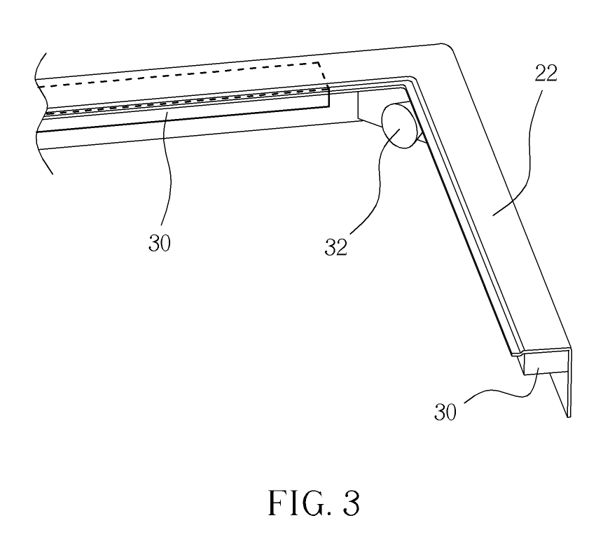

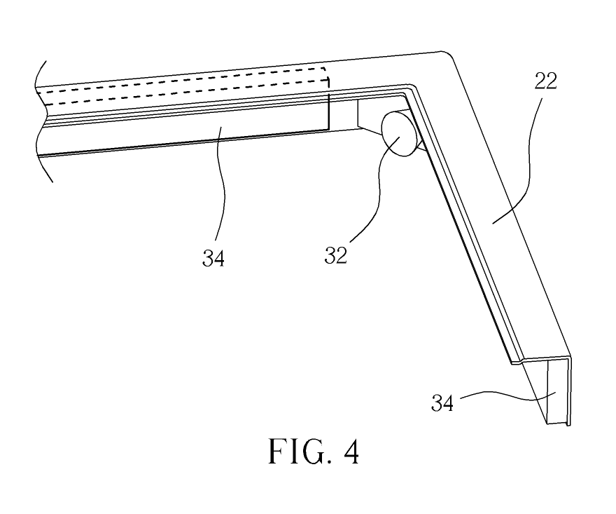

The light emitting element is disposed on the inside surface of the bezel, and may be on the horizontal or vertical surface of the inside surface of the bezel. It is necessary for the light emitted from the light emitting element to reach over the image display side of the LCD display. FIG. 3 illustrates an embodiment in which the light emitting elements 30 and the optical sensor 32 are disposed on the horizontal surface of the inside surface of the bezel 22. FIG. 4 illustrates an embodiment in which the light emitting elements 34 and the optical sensor 32 are disposed on the vertical surface of the inside surface of the bezel 22.

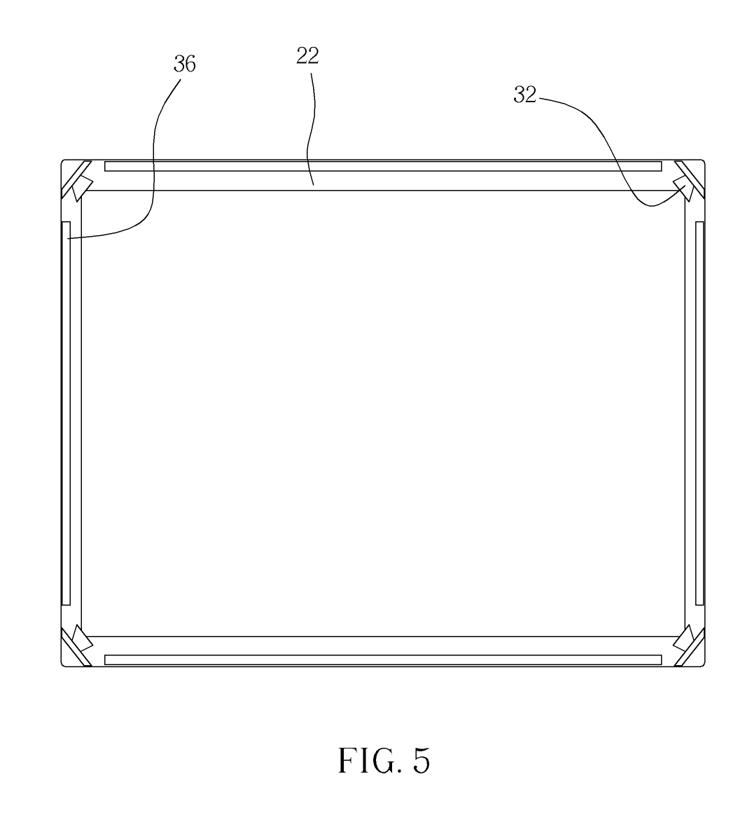

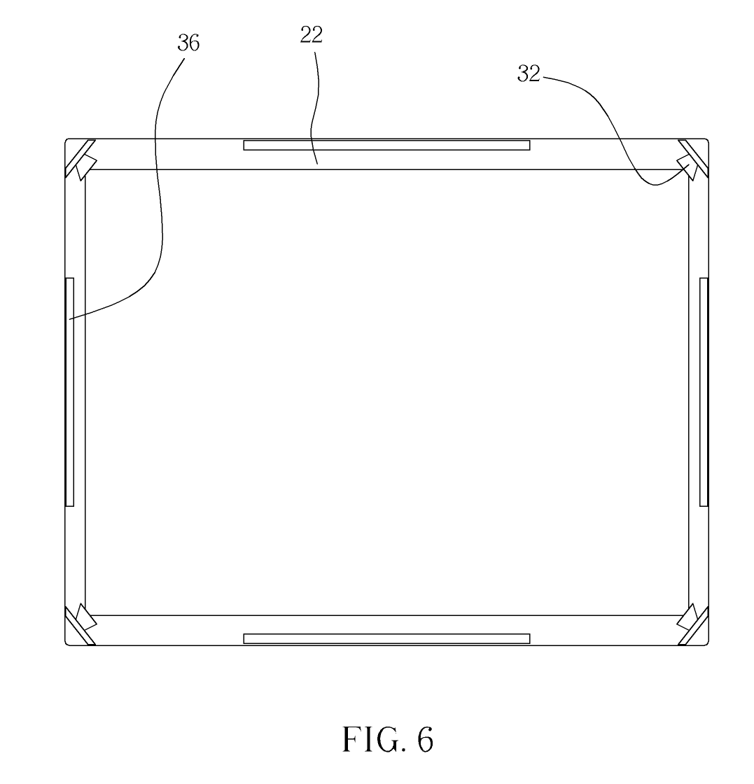

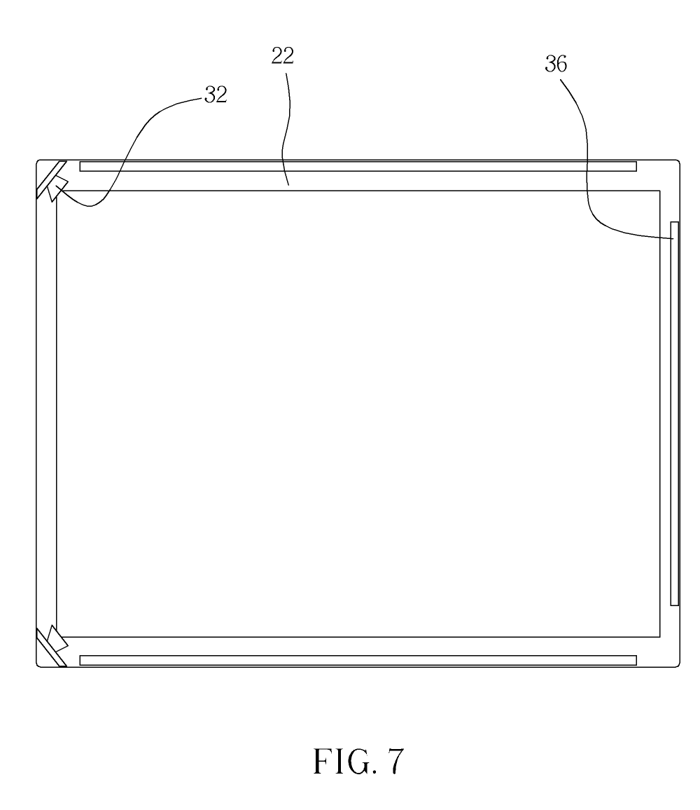

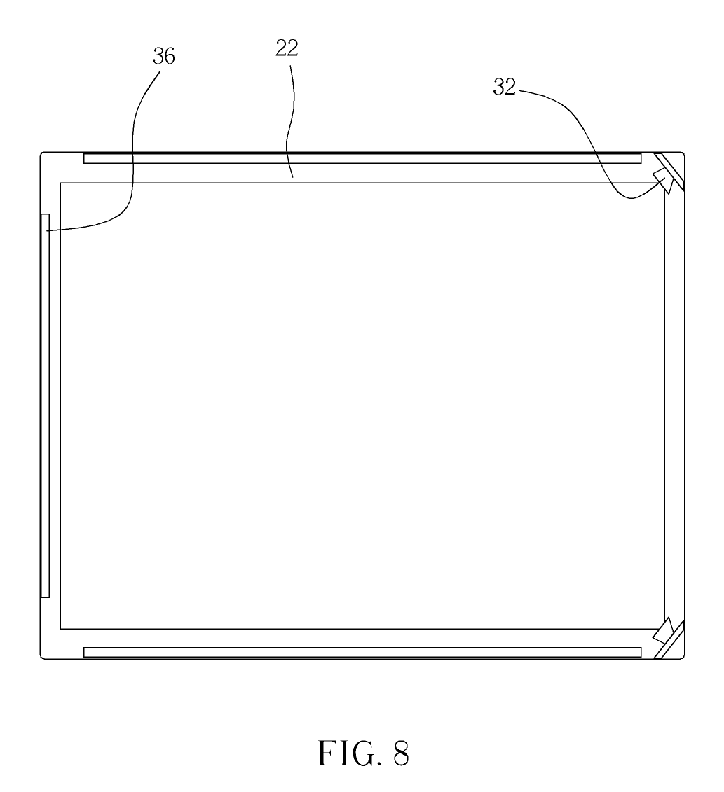

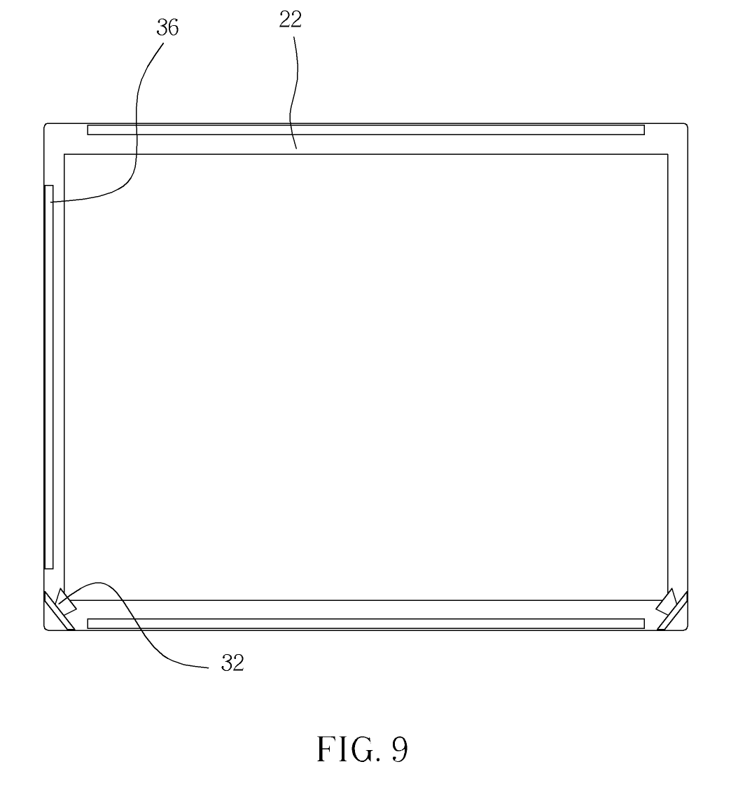

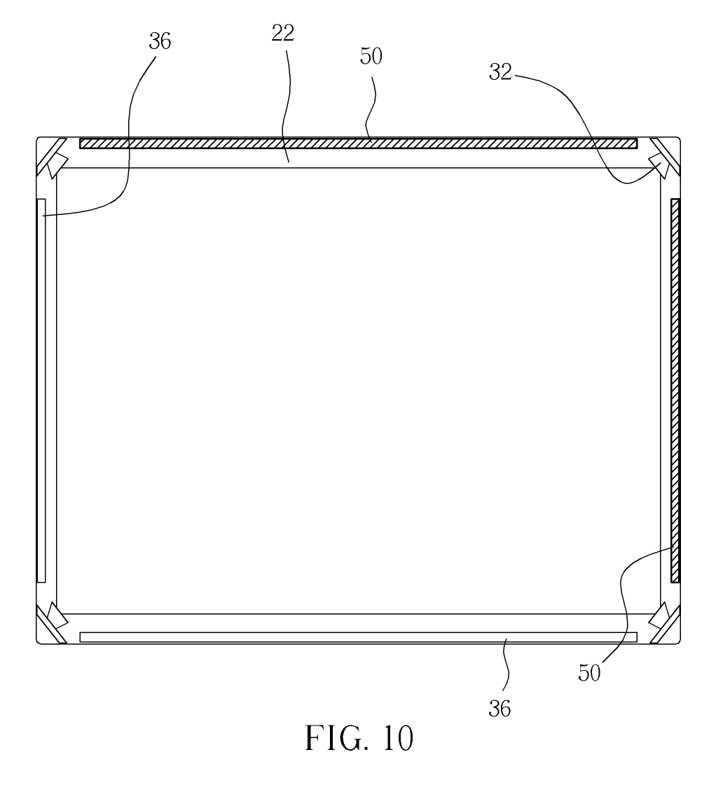

The number, size, and location on the inside surface of the bezel for the light emitting elements may be determined as desired. The number, size, and location on the inside surface of the bezel for the optical sensors also may be determined as desired. FIGS. 5-11 illustrate some embodiments, but not limited thereto. For instance, in the embodiment illustrated by FIG. 5, there are four light emitting elements 36 disposed on the inside surface of the bezel 22 at the four sides respectively. The length of each light emitting element is about equivalent to that of each side. There are also four optical sensors 32 disposed on the inside surface of the bezel 22 at the four corners, respectively. In the embodiment illustrated by FIG. 6, the four light emitting elements 36 are shorter and disposed on the inside surface of the bezel 22 at the middle of the four sides respectively. In the embodiment illustrated by FIG. 7, there are three light emitting elements 36 disposed on the inside surface of the bezel 22 at three of the four sides, respectively. The length of each light emitting element is about equivalent to that of each side. No light emitting element is disposed at the fourth sides; while, there are two optical sensors 32 disposed at two corners at the two ends of the fourth side, respectively. FIG. 8 illustrates an embodiment having a reversed layout of the embodiment illustrated by FIG. 7. The location of the optical sensor is not limited to only the two corners at the two ends of the fourth side without the light emitting element, i.e., the optical sensor can be disposed in the two corners at the two ends of the side having the light emitting element disposed thereon, as shown in FIG. 9. The number of the light emitting elements can be reduced through utilization of light-reflecting devices. For instance, in the embodiment illustrated by FIG. 10, the light-reflecting device 50 is disposed at the side opposing to the light emitting element 36. The light-reflecting device may be for example a light-reflecting plate to reflect the light emitted from the light-emitting element.

There is at least an optical sensor for detecting touches from users on the image display side. When precise detection is desired, it is preferred to place at least two optical sensors to more precisely determine the position of touch. In addition, when there are four optical sensors disposed on the inside surface at four corners of the bezel respectively, the two adjacent ones of the four optical sensors are utilized for detecting touches, and the other two adjacent ones are utilized for detecting erroneous actions.

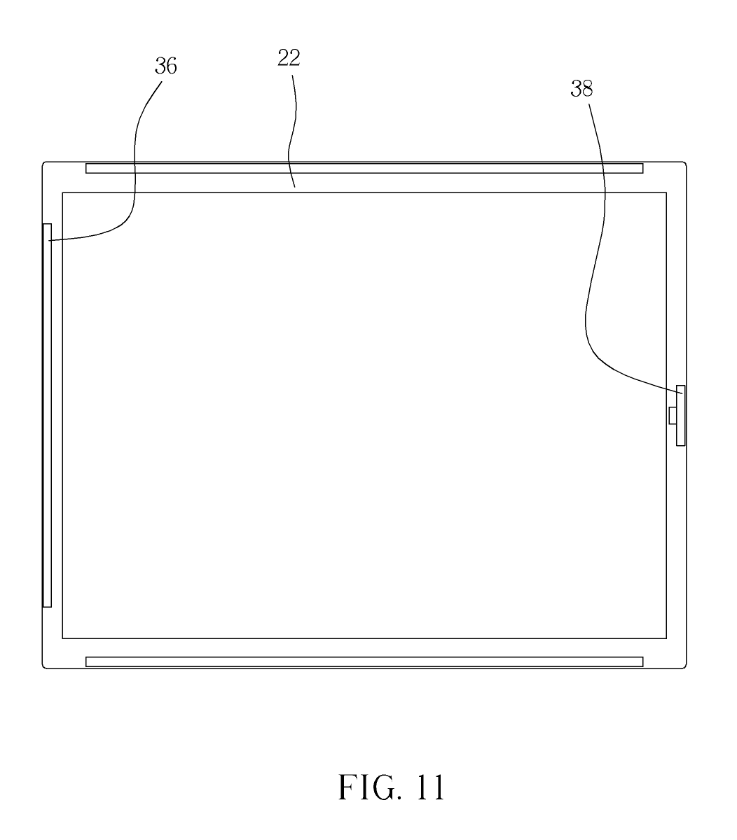

The number of the optical sensors does not particularly correlate with the location of the optical sensors, but it is preferred that touches all over on the image display side can be detected to avoid any omissions. Accordingly, there can be one or more optical sensors disposed on the inside surface of the corners or sides of the bezel. When the optical sensors are disposed at the sides of the bezel, it is preferred that they are not with any light emitting element at the same side. The optical sensors may be supported on the horizontal or vertical surface of the inside surface of the bezel by for example a holder. FIG. 11 illustrates an embodiment using an IR-CCD element for serving as the optical sensor of the present invention, in which only one IR-CCD element 38 is disposed on one side. The IR-CCD element 38 is a micro optical sensor, and it is rotatable and periscopic for detecting touches all over on the entire image display surface. Furthermore, if the optical sensor is a scanning type optical sensor and able to rotate, for example, 180 degrees, only one may be sufficient to be disposed on the inside surface of the middle of the side of the bezel. When the optical sensor can rotate, for example, 90 degrees, two may be required to be disposed on the inside surface of the middle of the side of the bezel, such that each detects touches on or over the image display surface ranging up to 90 degrees, respectively, for full detection on the entire display surface.

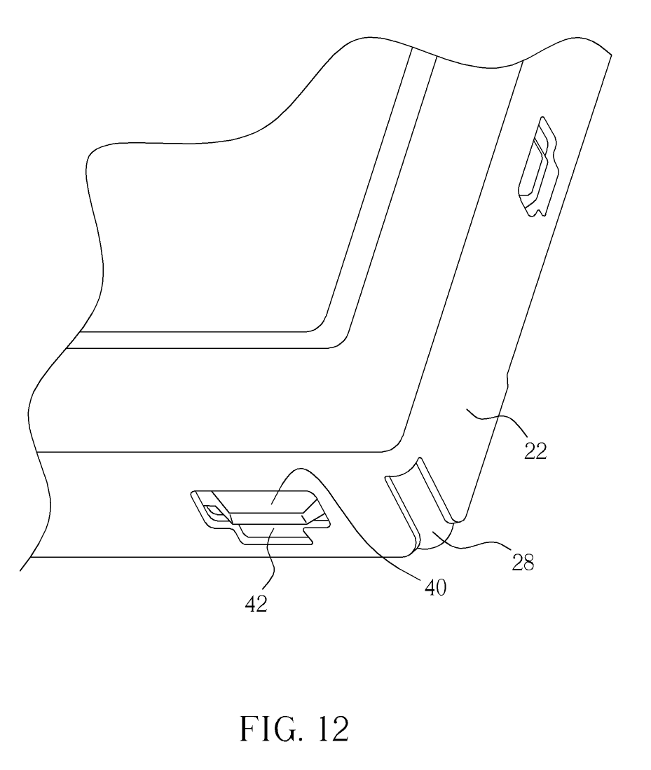

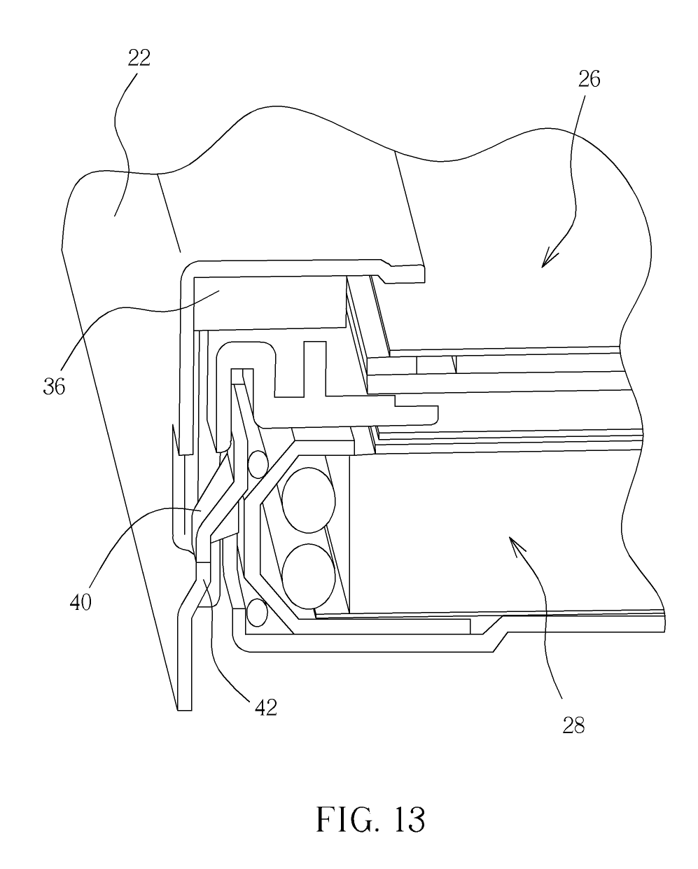

FIG. 12 illustrates one embodiment of the combination of the bezel 22 having the light emitting elements and the optical sensors disposed thereon and the backlight unit 28 in the present invention. The bezel 22 and the backlight unit 28 are buckled up through the female buckle 42 on the bezel and the male buckle 40 on the metal plate of the backlight unit 28. FIG. 13 shows such schematic cross-sectional view.

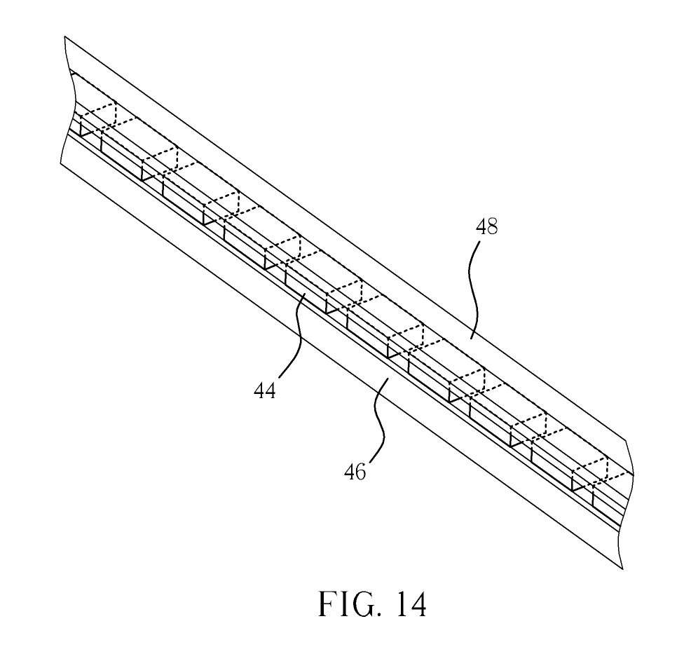

FIG. 14 is a schematic diagram illustrating the light emitting element structure in an embodiment of the present invention. A plurality of light emitting diode (LED) units 44 are disposed on a flexible flat cable 46 and a light guide bar 48 is disposed at the side of the LED unites 44 to form a light emitting element. The light guide bar 48 may comprise material of polymethylmethacrylate (PMMA) Furthermore, a dot-patterned light guide plate may be used for reducing the number of light emitting elements.

In comparison with conventional technologies, the optical touch technology is integrated into the LCD module in the present invention. Such technology is characterized in that the optical components serving touch functions are integrated in the bezel of an LCD module. It is novel and has improvements and advantages as follows.
1. The input function can be accomplished by continuous and multiple touches instead of conventional control mode of mouse, keyboard, and the like. When it is combined with a personal computer, the user can input data by hand gestures.
2. The brightness and the contract are higher than those of conventional resistance type or capacitance type touch LCD devices.
3. It is suitable for large size LCD devices, for example 50 inches or more.
4. Accuracy for touch identification is high and reaction time is quick.
5. Number of elements and time required for assembling the optical touch LCD display devices is reduced.
6. The thickness and the weight are reduced as compared with conventional optical touch LCD display devices.

Those skilled in the art will readily observe that numerous modifications and alterations of the device and method may be made while retaining the teachings of the invention.

What is claimed is:

1. An optical touch liquid crystal display device, comprising:
a liquid crystal display panel for displaying an image;
a backlight unit disposed beneath the liquid crystal display panel for providing a backlight for the liquid crystal display panel;
a bezel comprising an inside surface having a horizontal surface and a vertical surface, the bezel surrounding and fixing the liquid crystal display panel and the backlight unit;
at least a light emitting element disposed on the inside surface of the bezel for providing light to form an optical matrix at an image display side of the liquid crystal display panel; and
at least an optical sensor disposed on the inside surface of the bezel for detecting a touch on the liquid crystal display panel.

2. The optical touch liquid crystal display device of claim 1, wherein the light comprises invisible light.

3. The optical touch liquid crystal display device of claim 1, wherein the light comprises infrared light (IR) or far-infrared light.

4. The optical touch liquid crystal display device of claim 1, wherein the at least a light emitting element is disposed on the horizontal surface of the inside surface of the bezel.

5. The optical touch liquid crystal display device of claim 1, wherein the at least a light emitting element is disposed on the vertical surface of the inside surface of the bezel.

6. The optical touch liquid crystal display device of claim 1, wherein the optical touch liquid crystal display device comprises two optical sensors disposed on the inside surface at two adjacent corners of the bezel respectively for detecting a touch on the liquid crystal display panel.

7. The optical touch liquid crystal display device of claim 1, wherein, the optical touch liquid crystal display device comprises four optical sensors disposed on the inside surface at four corners of the bezel respectively, the two adjacent ones of the four optical sensors are for detecting a touch, and the other two adjacent ones are for detecting an erroneous action.

8. The optical touch liquid crystal display device of claim 1, further comprising a light guide plate or a diffusing plate disposed on the inside surface of the bezel and at a light-emitting side of the at least a light emitting element, wherein the light passes the light guide plate or the diffusing plate and forms the optical matrix on the image display side of the liquid crystal display panel.

9. The optical touch liquid crystal display device of claim 1, further comprising a light-reflecting device disposed on the inside surface of the bezel at a position opposite the at least a light emitting element for reflecting the light.

10. The optical touch liquid crystal display device of claim 1, wherein the bezel and the backlight unit are buckled up each other.

11. The optical touch liquid crystal display device of claim 1, wherein the at least an optical sensor is disposed on the inside surface of the bezel.

12. The optical touch liquid crystal display device of claim 1, wherein the at least an optical sensor is rotatable.
